(19) United States
(12) Patent Application Publication
(10) Pub. No.: US 2010/0254314 A1
(43) Pub. Date: Oct. 7, 2010

(54) WIRELESS COMMUNICATION TERMINAL

(75) Inventor: Hitoshi Tsuchiya, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/725,564

(22) Filed: Mar. 17, 2010

(30) Foreign Application Priority Data
Apr. 3, 2009 (JP) 2009-091398

(51) Int. Cl. H04W 88/02

(52) U.S. Cl. 370/328

(57) ABSTRACT

A wireless communication terminal comprises a communication unit, a detection unit, and a control unit. The communication unit wirelessly communicates with another communication terminal belonging to a wireless network where communication terminals directly communicate with each other and a communication terminal which does not belong to the wireless network. The detection unit detects a predetermined trigger. The control unit determines whether or not the communication unit is in a busy state with the other communication terminal belonging to the wireless network. The control unit controls the communication unit to prohibit transmission of a positive response to a connection request directed to the wireless network from the communication terminal which does not belong to the wireless network, upon detection of the trigger when determining that the communication unit is in the busy state with the other communication terminal.

### BACKGROUND OF THE INVENTION

1. Field of the Invention

The present invention relates to a wireless communication terminal which forms a wireless network for direct mutual communication between terminals.

Priority is claimed on Japanese Patent Application No. 2009-091398, filed Apr. 3, 2009, the content of which is incorporated herein by reference.

2. Description of Related Art

Among wireless network connection authentication methods which are receiving attention, as represented by WPS (Wi-Fi Protected Setup), a communication terminal (hereinafter, referred to as an “authentication requesting terminal”) requesting the connection authentication to join a wireless network wirelessly transmits an authentication request to an authenticating terminal, and receives connection setup data (for example, a network identifier, a communication encryption system, an encryption key, or the like) necessary for joining the wireless network from the authenticating terminal, such that a connection from the authentication requesting terminal is authenticated by the authenticating terminal to enable the authentication requesting terminal to join the network.

In WPS, there is a wireless network connection authentication method called “Push Button Configuration (hereinafter, referred to as “PBC”)” in which a connection start operation and an authentication instruction operation by a user are simple and convenient. In the PBC, both the authentication requesting terminal and the authenticating terminal may have operation buttons. After users push the operation buttons at both sides thereof, it is possible for the authentication requesting terminal to join the wireless network by authenticating a wireless connection between the authentication requesting terminal and the authenticating terminal regardless of user operation.

In the related art, the PBC is a connection authentication method in which the authentication requesting terminal joins a wireless network formed in an infrastructure mode in which a connection is made via an access point as the authenticating terminal. Thus, a connection from the authentication requesting terminal is authenticated by the access point as the authenticating terminal (for example, see Japanese Unexamined Patent Application, First Publication No. 2004-215232).

### SUMMARY OF THE INVENTION

In one aspect of the present invention, there is provided a wireless communication terminal that includes at least: a communication unit which wirelessly communicates with another communication terminal belonging to a wireless network where communication terminals directly communicate with each other and a communication terminal which does not belong to the wireless network; a detection unit which detects a predetermined trigger; and a control unit which determines whether or not the communication unit is in a busy state with the other communication terminal belonging to the wireless network, and controls the communication unit to prohibit transmission of a positive response to a connection request directed to the wireless network from the communication terminal which does not belong to the wireless network, upon detection of the trigger when determining that the communication unit is in the busy state with the other communication terminal.

Preferably, the wireless communication terminal according to the present invention may further comprise a display unit which displays predetermined data, and the control unit may control the display unit to display data indicating that wireless connection setup is impossible in the busy state with the other communication terminal.

Preferably, in the wireless communication terminal according to the present invention, the control unit may determine that the communication unit is in the busy state with the other communication terminal when the communication unit has input or output predetermined communication data within a predetermined time.

Preferably, in the wireless communication terminal according to the present invention, the control unit may determine that the communication unit is in the busy state with the other communication terminal when data is present in a buffer to be used by the communication unit.

Preferably, in the wireless communication terminal according to the present invention, the control unit may set a value to flag data indicating a busy state when predetermined communication data is input or output to or from the communication unit, and may determine that the communication unit is in the busy state with the other communication terminal based on the flag data.

Preferably, in the wireless communication terminal according to the present invention, the control unit may determine that the communication unit is in the busy state with the other communication terminal when a memory area, which the control unit uses to make the communication unit input or output predetermined communication data, is assigned to a memory unit.

### BRIEF DESCRIPTION OF THE DRAWINGS

The above features and advantages of the present invention will be more apparent from the following detailed description of certain preferred embodiments taken in conjunction with the accompanying drawings, in which:

FIG. 1 is a diagram showing the configuration of a wireless communication terminal forming a wireless network 1 and a wireless communication terminal 200 which sends an authentication request to a wireless communication terminal 100 belonging to the wireless network 1 according to an embodiment of the present invention;

FIG. 2 is a flowchart showing the operation of an application program 112 of the wireless communication terminal 100 according to an embodiment of the present invention;

FIG. 3 is a wireless connection setup sequence diagram showing the operations of an authentication requesting terminal and an authenticating terminal when a push operation signal has been input;

FIG. 4 is a wireless connection setup sequence diagram showing the operations of the authentication requesting terminal and the authenticating terminal when a number input operation signal has been input;

FIG. 5 is a wireless connection setup sequence diagram showing the operations of the authentication requesting terminal and the authenticating terminal when the authenticating terminal has received its own PIN code; and

FIG. 6 is a flowchart showing the operation of the application program 112 of the wireless communication terminal 100 according to an embodiment of the present invention.

### DETAILED DESCRIPTION OF THE PREFERRED EMBODIMENTS

The present invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

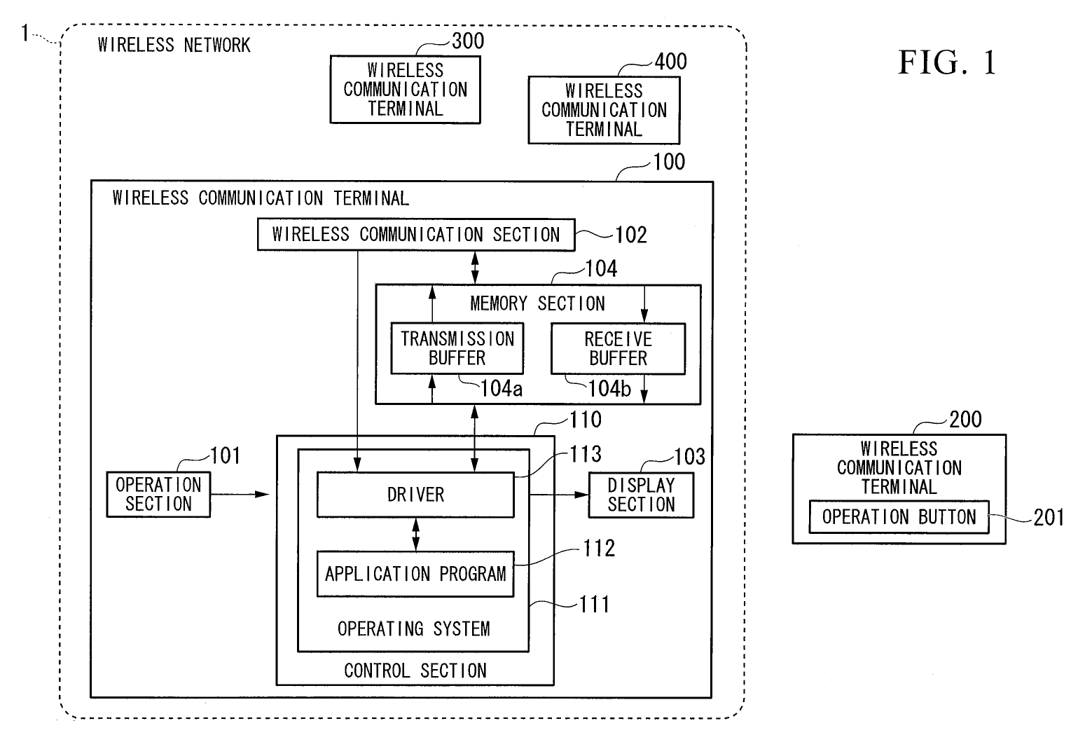

An embodiment for implementing the present invention will be described. FIG. 1 is a diagram showing the configuration of a wireless communication terminal forming a wireless network 1 and a wireless communication terminal 200 which sends an authentication request to a wireless communication terminal 100 belonging to the wireless network 1 according to an embodiment of the present invention. The wireless network 1 has the wireless communication terminal 100, a wireless communication terminal 300, and a wireless communication terminal 400. Here, the wireless communication terminal 200 does not belong to the wireless network 1.

The wireless communication terminal 100 has an operation section 101, a wireless communication section 102, a display section 103, a memory section 104, and a control section 110. For example, when a push operation on an operation button has been detected, the operation section 101 outputs a push operation signal to the control section 110. For example, when an operation of inputting a number such as a PIN (Personal Identification Number) code of the authentication requesting terminal has been detected, the operation section 101 outputs a number input operation signal to the application program 112 of the control section 110 or the like based on the PIN code input operation. Here, the input number is included in the number input operation signal. When an operation input for starting a process of wireless communication with another wireless communication terminal has been detected, the operation section 101 outputs a start signal to, for example, the application program 112.

The wireless communication terminal 200 also has an operation button 201 which is the same as that of the operation section 101.

The wireless communication section 102 acquires data stored in a transmission buffer 104a allocated to the memory section 104 and wirelessly communicates with another wireless communication terminal. The wireless communication section 102 receives data (for example, a probe request, an EAP (Extensible Authentication Protocol) request, or the like in WPS) transmitted from another wireless communication terminal, and outputs the received data to a driver 113 via a receive buffer 104b allocated to the memory section 104.

The wireless communication section 102 monitors a data input/output to/from its own section and notifies the application program 112 of the fact that no data has been input/output within a predetermined time via the driver 113 when no data has been input/output within the predetermined time. On the other hand, when data has been input/output within the predetermined time, the wireless communication section 102 notifies the application program 112 of the fact that the data has been input/output within the predetermined time via the driver 113.

For example, the display section 103 is a liquid crystal panel or the like, and is controlled from the application program 112 via an operating system 111. The display section 103 acquires and displays text data or the like from the application program 112. For example, the display section 103 may be an LED (Light Emitting Diode), and may change the emission color in response to control of the application program 112.

For example, the control section 110 is a central processing unit in which an operating system 111, the application program 112, and the driver 113 operate.

The operating system 111 assigns a memory area to be used by the driver 113 to the memory section 104. Thereby, the driver 113 starts a process. Further, the operating system 111 deletes the memory area to be used by the driver 113 from the memory section 104. Thereby, the driver 113 ends the process. The operating system 111 permits the driver 113 to be started up when a system call (service call) for permitting the driver 113 to be started up has been received from the application program 112. Further, the operating system 111 prohibits the driver 113 to be started up when a system call (service call) for prohibiting the driver 113 to be started up has been received from the application program 112.

When a system call (service call) of inquiring about whether or not data is stored in the receive buffer 104b or the transmission buffer 104a to be used by the driver 113 has been received from the application program 112, the operating system 111 outputs information indicating whether or not data is stored in at least one of the receive buffer 104b and the transmission buffer 104a to be used by the driver 113 to the application program 112.

When a system call (service call) of inquiring about whether or not the driver 113 is in a startup state has been received from the application program 112, the operating system 111 provides the application program 112 with information indicating whether or not the driver 113 is in the startup state and an identifier indicating whether or not the startup state is a startup state for inputting/outputting communication data to/from the wireless communication section 102.

When data has been input from the wireless communication section 102 to the control section 110, the operating system 111 starts the driver 113. When the driver 113 has output the data to the application program 112, the operating system 111 ends the driver 113. Likewise, the operating system 111 starts the driver 113 when data is output from the application program 112, and ends the driver 113 when the driver 113 has output the data from the control section 110.

The driver 113 operates as a communication driver, and provides the application program 112 with data which has been received by the wireless communication section 102 and temporarily stored (buffered) in the receive buffer 104b allocated to the memory section 104. The driver 113 stores data to be transmitted to the wireless communication section 102 in the transmission buffer 104a allocated to the memory section 104.

When a notification indicating whether data has been input/output within the predetermined time has been transmitted from the wireless communication section 102, the driver 113 transmits the notification to the application program 112.

When data has been input from the wireless communication section 102 to the control section 110, the driver 113 is started by the operating system 111. When the data has been output to the application program 112, the driver 113 is ended by the operating system 111. Likewise, when data is output from the application program 112, the driver 113 is started by the operating system 111. When the data has been completely output from the control section 110, the driver 113 is ended by the operating system 111.

The application program 112 outputs text data to the display section 103. The application program 112 acquires a push operation signal and a number input operation signal from the operation section 101. The application program 112 acquires its own PIN code from the wireless communication section 102 via the driver 113.

The application program 112 provides the operating system 111 with a system call (service call) for permitting the driver 113 to be started up or a system call (service call) for prohibiting the driver 113 to be started up.

For a determination as to whether or not it is in a busy state, there are the following determination conditions. When the first determination condition is used, the application program 112 transmits a system call (service call) of inquiring about whether or not the driver 113 is in the startup state to the operating system 111 in a predetermined cycle, and determines whether or not the driver 113 is in a “startup or startup standby state”. When the driver 113 is in the “startup or startup standby state” and the identifier indicates the startup for inputting/outputting communication data, the application program 112 determines that the driver 113 is in the busy state. On the other hand, when the driver 113 is not in a “startup or startup standby state”, the application program 112 determines that the driver 113 is not in a busy state.

When the second determination condition is used, the application program 112 transmits a system call (service call) of inquiring about whether or not communication data is stored in the receive buffer 104b or the transmission buffer 104a to be used by the driver 113 to the operating system 111 in a predetermined cycle, and determines whether or not the communication data is stored in at least one of the receive buffer 104b and the transmission buffer 104a to be used by the driver 113. When the communication data is stored in at least one of the receive buffer 104b and the transmission buffer 104a to be used by the driver 113, the application program 112 determines that the driver 113 is in the busy state. On the other hand, when no communication data is stored in at least one of the receive buffer 104b and the transmission buffer 104a, the application program 112 determines that the driver 113 is not in the busy state.

When the third determination condition is used, the application program 112 determines that the wireless communication section 102 is not in the busy state upon receipt of a notification indicating that no data has been input/output to/from the wireless communication section 102 within a predetermined time from the driver 113. On the other hand, when data has been input/output to/from the wireless communication section 102 within the predetermined time, the application program 112 determines that the wireless communication section 102 is in the busy state.

The application program 112 acquires data, which has been received by the wireless communication section 102 and stored in the receive buffer 104b allocated to the memory section 104, from the driver 113. The application program 112 provides the driver 113 with predetermined data to be transmitted to another wireless communication terminal.

When the application program 112 is in a busy state, that is, has provided the driver 113 with predetermined data to be transmitted to the wireless communication terminal, the application program 112 adds a value “1” to a flag (initial value “0”) indicating the busy state and stores the addition result in the memory section 104. When a notification indicating that data output to the driver 113 has been completely transmitted by the wireless communication section 102 has been received from the driver execution section, the application program 112 subtracts the value “1” from the flag indicating a busy state, and stores the subtraction result in the memory section 104. A plurality of application program 112 may be in the busy state. When the flag indicating the busy state is not the value “0”, it indicates that one application program 112 is in a busy state.

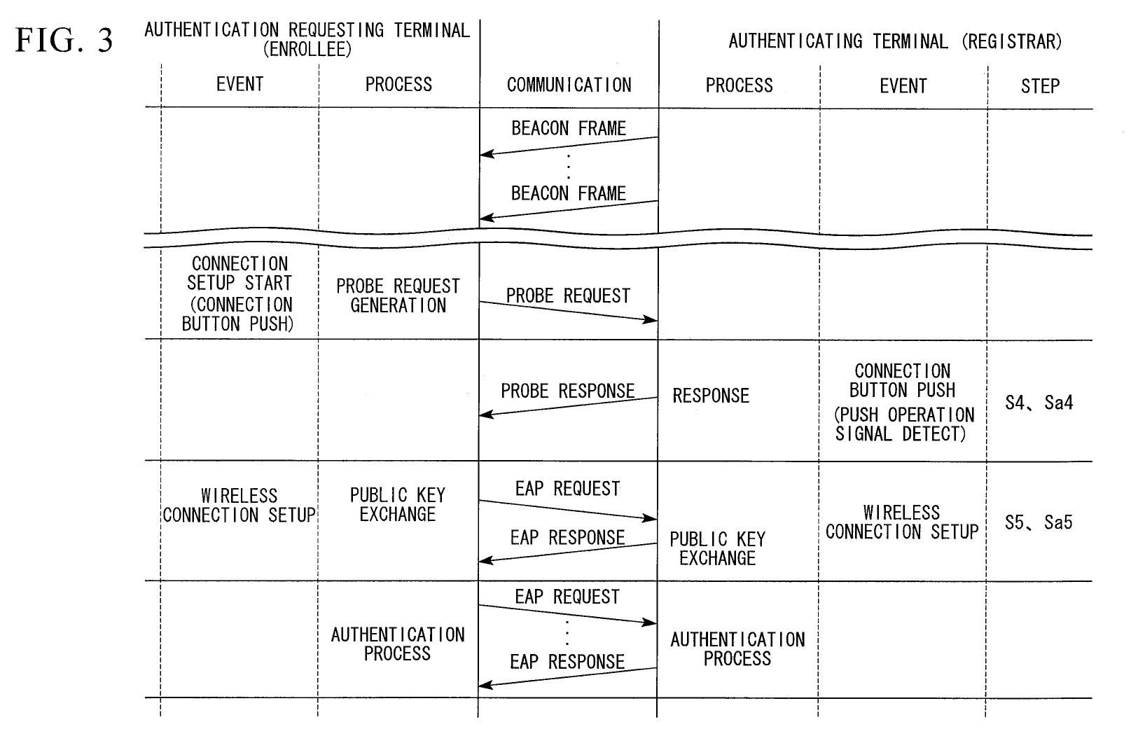

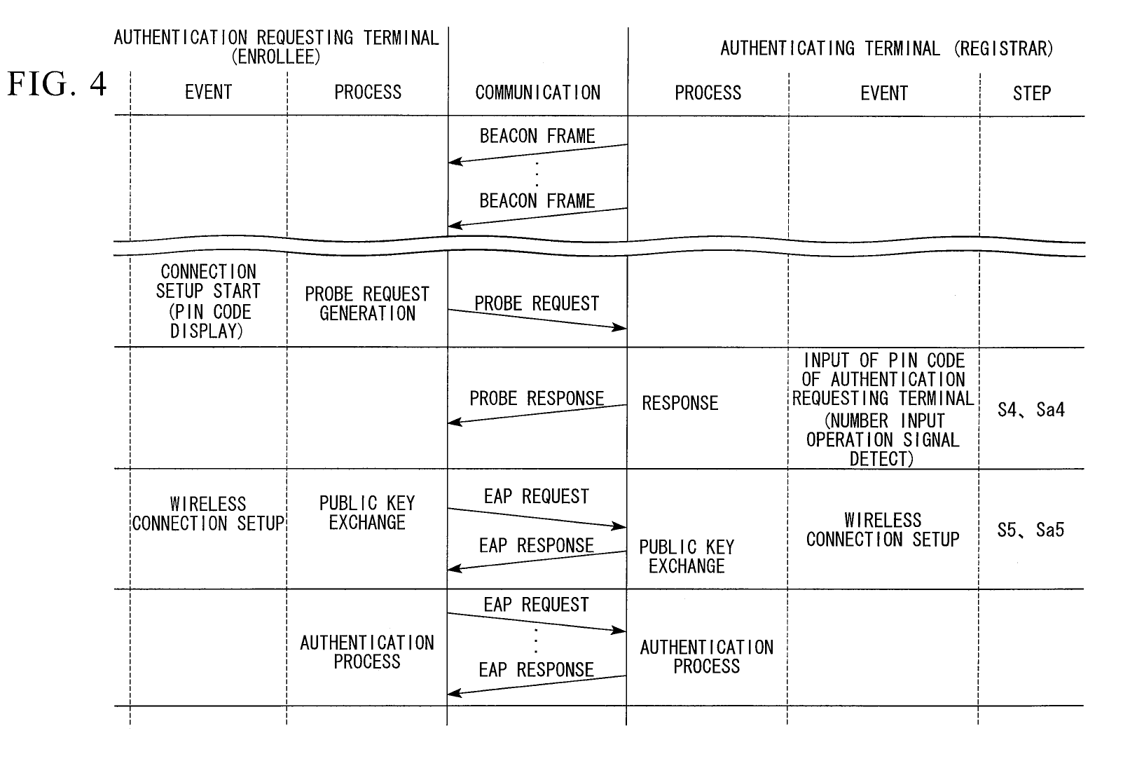

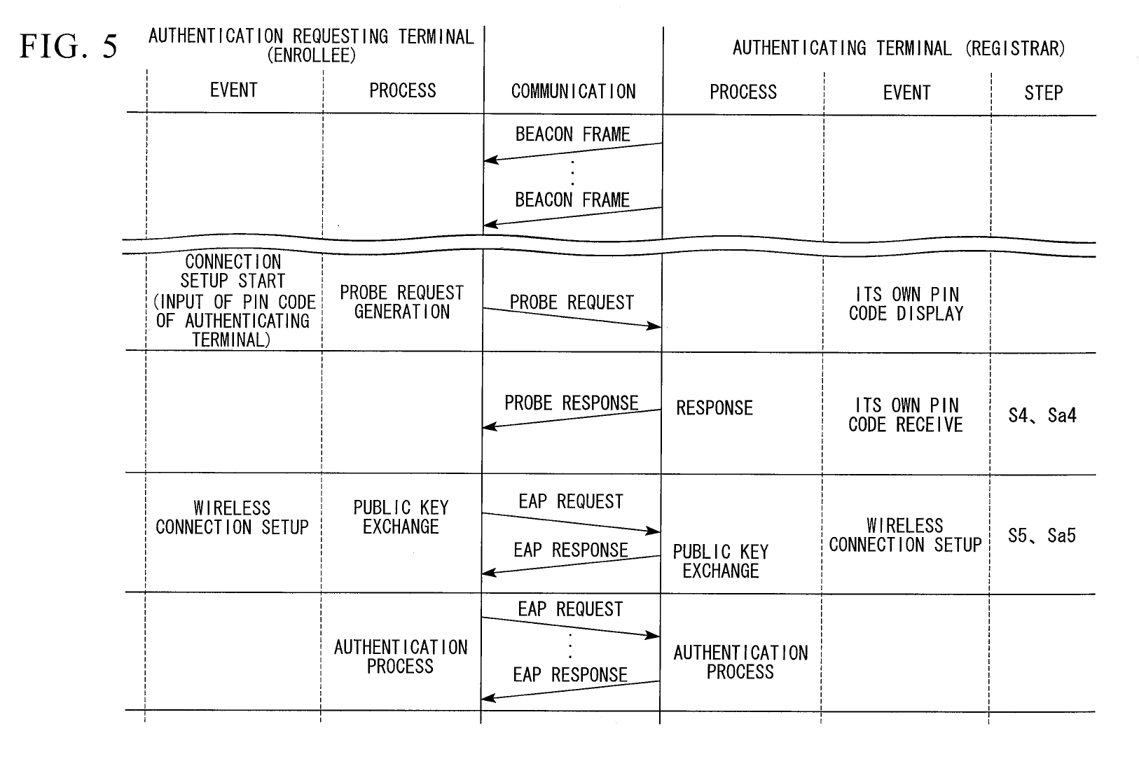

When the wireless communication section 102 has received an authentication request (for example, a probe request in WPS) and has also detected a push operation signal or a number input operation signal from the operation section 101, the application program 112 transmits a probe response (positive response) to an authentication requesting terminal and sets up a wireless connection with the wireless communication terminal (authentication requesting terminal) transmitting the authentication request (as described later with reference to FIGS. 3 and 4). That is, when a detection trigger of the push operation signal or the number input operation signal has been detected, the above-described wireless connection setup is performed. When the wireless communication section 102 has received its own PIN code included in the probe request, the probe response (positive response) is transmitted to the authentication requesting terminal and the wireless connection setup with the wireless communication terminal (authentication requesting terminal) transmitting the authentication request is performed (as described later with reference to FIG. 5). The application program 112 also executes a connection authentication process after performing the wireless connection setup. That is, when a start trigger of its own PIN code has been detected, the above-described wireless connection setup is performed. Accordingly, the application program 112 of the control section 110 is also a detection section which detects the trigger.

The application program 112 creates text data to be displayed on the display section 103, for example, the expression “Wireless connection setup with another terminal is possible.” when it is not in a busy state with another terminal or the expression “It is in a busy state with another terminal. Wireless connection setup for connection authentication is not possible.” when it is in a busy state with another terminal, and outputs the created text data to the display section 103.

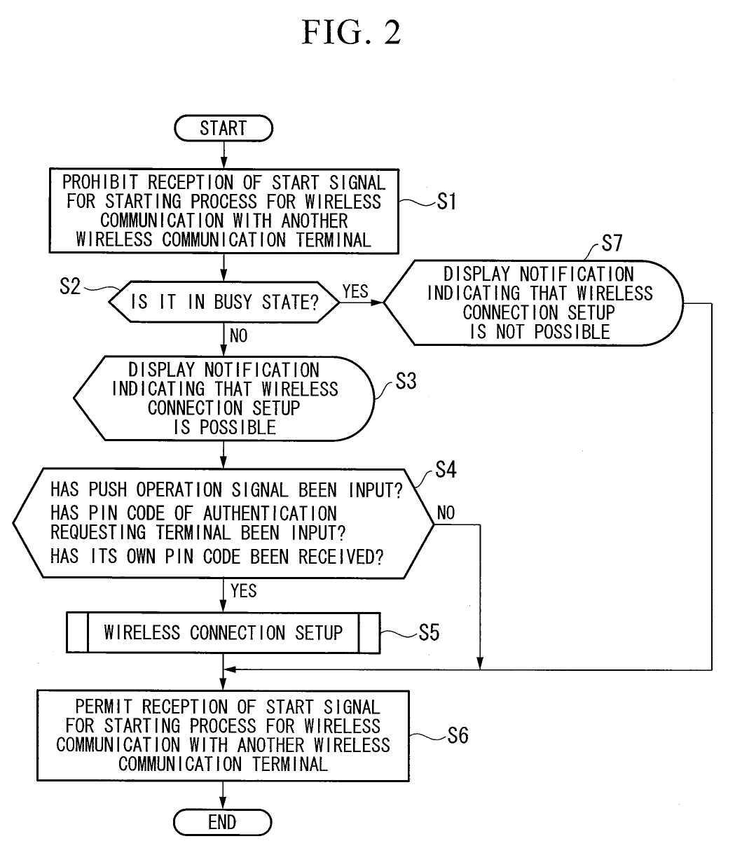

FIG. 2 is a flowchart showing the operation of the application program 112 of the wireless communication terminal 100 according to an embodiment of the present invention. Hereinafter, there will be described the case where the wireless communication terminal 200 transmits authentication request data to the wireless communication terminal 100 when the users push the operation buttons of both the wireless communication terminal 100 (the authenticating terminal) and the wireless communication terminal 200 (the authentication requesting terminal) so as to cause the wireless communication terminal 200 to join the wireless network 1. The application program 112 performs the operation shown in the flowchart of FIG. 2 in a predetermined cycle (for example, a cycle of 100 ms).

When the user performs a push operation on the operation button 201 of the wireless communication terminal 200, the wireless communication terminal 200 wirelessly transmits the authentication request. The wireless communication section 102 receives the authentication request transmitted by the wireless communication terminal 200. The wireless communication section 102 outputs the authentication request to the receive buffer 104b allocated to the memory section 104.

Since data has been input, the operating system 111 starts the driver 113. The driver 113 outputs data (the authentication request or the like) temporarily stored in the receive buffer 104b to the application program 112. The operating system 111 ends the driver 113.

The application program 112 prohibits the startup a process of wireless communication setup with another wireless communication terminal. For example, when a “start signal” of requesting the start of a video playback process while acquiring video file data stored in another wireless communication terminal has been output from the operation section 101, the application program 112 does not start the process of acquiring video file data by wireless communication without receiving the start signal. Thus, the application program 112 prevents wireless connection setup from being changed in the busy state (step S1).

Next, the application program 112 determines whether or not it is in the busy state with another communication terminal using one of the above-described determination conditions. For example, the application program 112 transmits a system call (service call) of inquiring about whether or not communication data is stored in the receive buffer 104b or the transmission buffer 104a to be used by the driver 113 to the operating system 111, and determines whether or not data is stored in at least one of the receive buffer 104b and the transmission buffer 104a to be used by the driver 113 (step S2). The application program 112 creates text data “It is in the busy state with another terminal. Wireless connection setup for connection authentication is not possible.”, when determining that it is in a busy state, and outputs the created text data to the display section 103.

The operating system 111 starts the driver 113. The driver 113 outputs the acquired text data to the display section 103. The operating system 111 ends the driver 113. The display section 103 displays the input text data or the like. For example, the display section 103 may be lighted in red (step S7). Thereafter, the application program 112 permits the startup a process of wireless connection setup for wireless communication with another wireless communication terminal (step S6).

On the other hand, when determining that it is not in the busy state in step S2, the application program 112 creates text data, for example “Wireless connection setup is possible since it is not in the busy state with another communication terminal.” and displays the created text data to the display section 103. The display section 103 displays the input text data or the like. For example, the display section 103 may be lighted in green by an LED (step S3).

Subsequently, the application program 112 determines whether or not a push operation signal or whether or not a number input operation signal has been input or its own PIN code has been received (step S4). That is, a trigger of the input of the push operation signal or the number input operation signal or the start trigger of its own PIN code is detected. FIG. 3 is a WPS sequence diagram showing the operations of the authentication requesting terminal and the authenticating terminal when the push operation signal has been input. FIG. 4 is a wireless connection setup sequence diagram showing the operations of the authentication requesting terminal and the authenticating terminal when the number input operation signal has been input.

In step S3, it is assumed that the user identifying the display of a notification indicating that wireless connection setup is possible has made the push operation or the number input operation (the operation of inputting the PIN code of the authentication requesting terminal) on the operation section 101. Since the operation by the user has been detected, the operation section 101 outputs the push operation signal or the number input operation signal to the control section 110 based on the operation input. The application program 112 of the control section 110 acquires data included in the push operation signal or the number input operation signal. Using this as a trigger, the application program 112 exchanges a public key using an EAP request and an EAP response in wireless connection setup and performs wireless connection setup.

FIG. 5 is a wireless connection setup sequence diagram showing the operations of the authentication requesting terminal and the authenticating terminal when the authenticating terminal has received its own PIN code. Here, it is assumed that the wireless communication section 102 has received its own PIN code included in the probe request. The wireless communication section 102 outputs its own received PIN code to the control section 110. The application program 112 of the control section 110 identifies whether the received PIN code matches its own PIN code displayed on the display section 103. When the matching has been identified, it is used as a trigger, a public key is exchanged using an EAP request and an EAP response in wireless connection setup, and wireless connection setup is performed (step S5).

The application program 112 executes the connection authentication by wireless connection setup after performing the wireless connection setup (FIGS. 3, 4, and 5). Further, the application program 112 proceeds to step S6 and ends the process.

### Second Embodiment

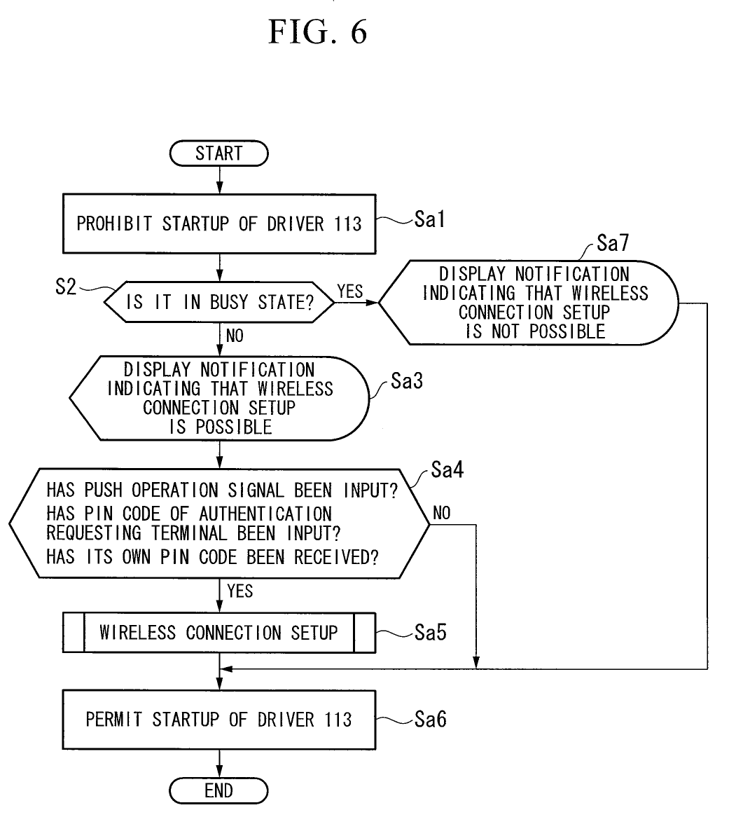

The configuration of each block is the same as that of the first embodiment (FIG. 1). A wireless connection setup sequence diagram (FIGS. 3 to 5) showing the operations of the authentication requesting terminal and the authenticating terminal is the same. The flowchart shown in FIG. 2 may be the same as follows. FIG. 6 is a flowchart showing the operation of the application program 112 of the wireless communication terminal 100 according to an embodiment of the present invention. The application program 112 performs the operation shown in the flowchart of FIG. 6 in a predetermined cycle (for example, a cycle of 100 ms).

Since an authentication request has been received, the application program 112 transmits a system call (service call) for prohibiting the startup of the driver 113 to the operating system 111. Thereby, the operating system 111 prohibits the startup of the driver 113. Another driver execution section started up in the operating system 111 is prevented from operating the transmission buffer 104a or the receive buffer 104b (step Sa1).

Steps Sa2 to Sa5 are the same as steps S2 to S5 of FIG. 2. After step Sa5 or Sa7, the application program 112 transmits a system call (service call) for permitting the startup of the driver 113 to the operating system 111. The operating system 111 permits the startup of the driver 113 (step Sa6). Step Sa7 is the same as step S7 of FIG. 2.

When the wireless communication terminal 100 is in the busy state with another wireless communication terminal in the wireless network 1 formed in an ad-hoc mode according to an embodiment of the present invention, communication in a connection state is not stopped since the wireless communication terminal 100 receiving the authentication request transmitted from the wireless communication terminal 200 does not make wireless connection setup with the wireless communication terminal 200.

Since the wireless communication terminal 100 is already in the busy state with the other wireless communication terminal, the user can be notified of the fact that a connection of the wireless communication terminal 200 is not authenticated.

While the exemplary embodiments of the invention have been described with reference to the accompanying drawings, the detailed constitutions of the invention are not limited to the foregoing embodiments but embrace changes in design to the extent that they do not depart from the concept of the invention.

A wireless communication terminal described in the present invention corresponds to the wireless communication terminal 100, another communication terminal belonging to a wireless network corresponds to the wireless communication terminal 300 and the wireless communication terminal 400, a communication terminal which does not belong to the wireless network corresponds to the wireless communication terminal 200, a communication section corresponds to the wireless communication section 102, a control section corresponds to the control section 110, a detection section corresponds to the control section 110 and the application program 112, a display section corresponds to the display section 103, and a memory section corresponds to the memory section 104.

A program for implementing the steps shown in FIG. 2 may be recorded on a computer-readable recording medium, and a process of a wireless terminal may be executed by reading the program recorded on this recording medium into a computer system. Here, the “computer system” may also include an OS (Operating System) and hardware such as peripheral devices.

When a WWW system is used, the “computer system” also includes a homepage provision environment (or display environment). Moreover, the “computer-readable recording medium” refers to a writable non-volatile memory such as a flexible disc, a magneto-optical disc, a ROM, or a flash memory, a portable medium such as a CD-ROM, or a memory device such as a hard disc built into the computer system.

Furthermore, the “computer readable memory medium” also includes a medium, which holds a program for a given time, such as a volatile memory (for example, DRAM (Dynamic Random Access Memory) inside a computer system which becomes a server or a client when the program is sent via a network such as the Internet or a communication circuit such as a telephone circuit.

The above-described program may be transmitted from a computer system where the program is stored in a memory device or the like to another computer system via a transmission medium, or by transmission waves within the transmission medium. Here, for example, the “transmission medium” on which the program is transmitted is a medium having an information transmission function like a network (communication network) such as the Internet or a communication circuit (communication line) such as a telephone circuit.

The above-described program may be used to implement part of the above-described function. In addition, the program may be a so-called differential file (differential program) capable of implementing the above-described function in combination with a program already recorded on the computer system.

What is claimed is:

1. A wireless communication terminal comprising:
a communication unit which wirelessly communicates with another communication terminal belonging to a wireless network where communication terminals directly communicate with each other and a communication terminal which does not belong to the wireless network;
a detection unit which detects a predetermined trigger; and
a control unit which determines whether or not the communication unit is in a busy state with the other communication terminal belonging to the wireless network, and controls the communication unit to prohibit transmission of a positive response to a connection request directed to the wireless network from the communication terminal which does not belong to the wireless network, upon detection of the trigger when determining that the communication unit is in the busy state with the other communication terminal.

2. The wireless communication terminal according to claim 1, further comprising a display unit which displays predetermined data,
wherein the control unit controls the display unit to display data indicating that wireless connection setup is impossible in the busy state with the other communication terminal.

3. The wireless communication terminal according to claim 1, wherein the control unit determines that the communication unit is in the busy state with the other communication terminal when the communication unit has input or output predetermined communication data within a predetermined time.

4. The wireless communication terminal according to claim 1, wherein the control unit determines that the communication unit is in the busy state with the other communication terminal when data is present in a buffer to be used by the communication unit.

5. The wireless communication terminal according to claim 1, wherein the control unit sets a value to flag data indicating a busy state when predetermined communication data is input or output to or from the communication unit, and determines that the communication unit is in the busy state with the other communication terminal based on the flag data.

6. The wireless communication terminal according to claim 1, wherein the control unit determines that the communication unit is in the busy state with the other communication terminal when a memory area, which the control unit uses to make the communication unit input or output predetermined communication data, is assigned to a memory unit.
